(19) United States
(12) Patent Application Publication
(10) Pub. No.: US 2012/0023277 A1
(43) Pub. Date: Jan. 26, 2012

(54) Method for Operating an Automation Device

(75) Inventors: Markus GRAF, Rulzheim (DE); Hanns Zwosta, Uttenreuth (DE)

(73) Assignee: Siemens Aktiengesellschaft, Munchen (DE)

(21) Appl. No.: 13/184,365

(22) Filed: Jul. 15, 2011

(30) Foreign Application Priority Data
Jul. 16, 2010 (EP) EP10169885

(51) Int. Cl. G06F 13/00

(52) U.S. Cl. 710/110

(57) ABSTRACT

A method for operating an automation device comprising at least one master unit and at least one slave unit that is connected by a first bus, wherein messages are transmitted over the first bus while controlling a technical process. The messages comprise a process image data area for planned field devices, which are connected to the at least one slave unit by a second bus, and a planned reserved process image data area that is intended for possible expansions of the automation device with further field devices is connectable to the at least one slave unit. In accordance with the invention, the method is used to expand the automation device with field devices, i.e., field devices that comply with the Fieldbus Foundation specification, during control operation (RUN operation).

### BACKGROUND OF THE INVENTION

1. Field of the Invention

The present invention relates to machine automation and, more particularly, to a method for operating an automation device comprising at least one master unit and at least one slave unit that is connected by a first bus, where messages are transmitted over the first bus while controlling a technical process, each of the messages comprise a process image data area for planned field devices, which are connected to the at least one slave unit by a second bus, and a planned reserved process image data area that is intended for possible expansions of the automation device with at least one further field device that is connectable to the at least one slave unit. In addition, the invention relates to an automation device that is configured to perform the method.

2. Description of the Related Art

EP 1 495 376 discloses a conventional method and an automation device. During a planning phase, a user plans a useful data area and a reserve useful data area for a slave unit using an engineering system, where the reserve useful data area is intended for expansion of a slave unit with at least one slave subassembly, such as a slave subassembly comprising an analog input/output subassembly or a digital input/output subassembly. The CPU unit or the master unit of a programmable logic controller uses a message to gain read or write access to these data areas and, if the slave unit is actually expanded by a slave subassembly during ongoing control operation or during control of a technical process, such access is effected smoothly and without reaction for all master and slave units connected to the bus based on the planned reserve useful data area. Here, the CPU or master unit need not be moved from RUN operation to a STOP state for the expansion. Measures for expanding the automation device in a substantially smooth manner and without reaction with a field device that complies with the Fieldbus Foundation specification, for example, have not been provided.

Field devices that comply with the Fieldbus Foundation specification (i.e., FF devices) undertake process control functions, where each FF device interchanges data with another FF device over an FF bus during distributed communication. For this purpose, a central communication controller that controls the temporal progress of bus communication is provided for this purpose, for example a Link Active Scheduler (LAS) having a scheduler. During unclocked data transmission, this communication controller undertakes non-time-critical tasks, such as the transmission of device parameters to the field devices. In contrast, time-critical tasks, such as tasks comprising reading, processing or outputting process data, are performed using the communication controller during clocked data transmission in accordance with a transmission list, where the transmission list indicates the time at which a field device is requested to transmit its data and the time at which a field device can read these data.

### SUMMARY OF THE INVENTION

It is an object of the present invention to provide a method for expanding an automation device with field devices, i.e., field devices that comply with the Fieldbus Foundation specification, during control operation (RUN operation). In addition, it is an object to provide an automation device that is configured to perform the method of the invention.

These and other objects and advantages are achieved by providing an automation device and method in which parameters of field devices, a further field device and communication relationships, i.e., schedulers or virtual communication relationships (VCR's), of the field devices and further field device are stored in a slave unit over a first bus, and an engineering system transmits a system data module for the slave unit to the master unit, where the system data module is stored in the master unit and the slave unit and comprises addresses of the field devices and the further field device, configuration data having a number of input and output variables of the field devices and the further field device, and a distribution of the input and output variables in the process image data area.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, its refinements and advantages are explained in more detail below using the drawings which illustrate an exemplary embodiment of the invention, in which.

FIG. 1 is a schematic block diagram of an automation device;

FIG. 2 is an illustration of a library of Field Bus Foundation;

FIG. 3 shows an engineering and runtime overview; and

FIG. 4 is a flow chart of the method in accordance with an embodiment of the invention.

### DETAILED DESCRIPTION OF THE PRESENTLY PREFERRED EMBODIMENTS

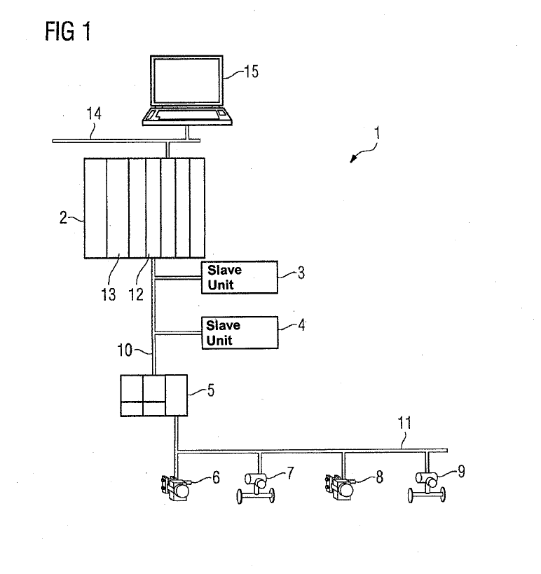

FIG. 1 shows an automation device 1 having an automation instrument 2, slave units 3, 4, 5 and a plurality of field devices 6, 7, 8, 9. In accordance with the invention, the slave units 3, 4 comprise, for example, decentralized peripherals that are each provided with a plurality of digital or analog input/output subassemblies for connecting solenoid valves, contactors, resistance thermometers or other actuators or sensors. In the presently contemplated embodiment, the slave unit 5 is a Distributed Peripherals/Fieldbus Foundation (DP/FF) link that implements a bus transition from a first bus 10 to a second bus 11, where the first bus 10 comprises a conventional peripheral bus “Profibus DP”, and is configured for high communication speeds. The second bus 11 comprises a conventional Fieldbus Foundation (FF) bus that that meets the requirements of the Fieldbus Foundation specification.

The field devices 6, 7, 8, 9 (FF field devices) are connected to the second bus 11. The slave units 3, 4, 5 are connected by the first bus 10 to a master subassembly 12 of the automation instrument 2 which has a CPU subassembly 13 and further subassemblies which are coupled via a backplane bus, for example, subassemblies comprising regulator, input/output and/or other functional subassemblies. It should be appreciated that the automation device 1 may be provided with further automation instruments, decentralized peripherals and/or field devices depending on a control or automation task to be implemented. Depending on this task, a user plans and/or configures the automation device 1 using an engineering system 15 that is connected to the automation instrument 2 by for example, an industrial Ethernet communication link 14. For this purpose, the engineering system 15 has a suitable software tool that displays a hardware library to the user in a window of a display unit of the engineering system 15 and makes it possible for the user to initially select hardware components from this library by “drag & drop” using a control element to copy the selected components to a further window of the display unit and to connect the components to one another in accordance with the control task to be implemented. The software tool automatically allocates addresses to the selected field devices or proposes addresses to the user, where the addresses are acceptable or changeable by the user.

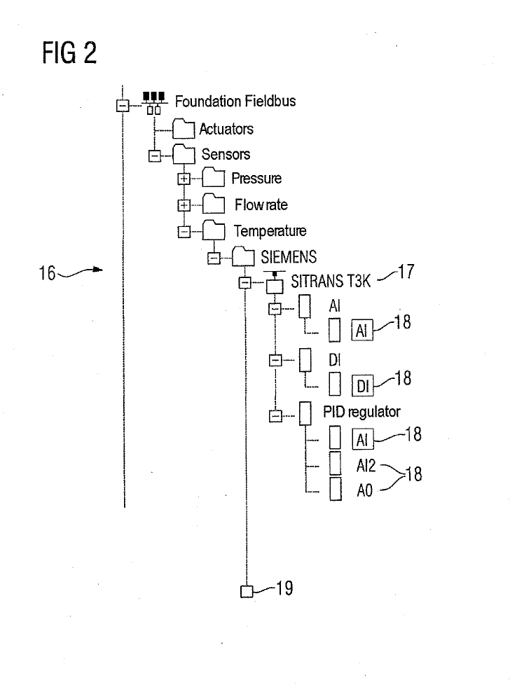

With specific reference to FIG. 2, illustrated there in is a library or catalog 16 that is provided with a plurality of directories or folders. Here, it is assumed that the user selects a field device 17 with associated function blocks 18 and also, in a detailed view (not shown), input and output variables (I/O data) of these function blocks 18. It is also assumed that the user selects a Configuration in RUN (CiR) field device 19 that is provided and represents expansion of the automation device 1 with a further field device.

The software tool uses these selected input and output variables and default values for the CiR field device 19 to generate the part of a Profibus DP message that is intended for cyclical information interchange between the automation instrument 2 and the slave unit 5 over the first bus 10, and comprises a process image data area for the planned input and output variables and a planned reserved process image data area that is initially occupied by the default values. It thus follows saying that the Profibus DP message also comprises information relating to the further slave units 3, 4. These slave units 3, 4 and their effects on the DP message are not important within the context of the embodiments of the invention and are therefore not considered in the below description for the sake of simplicity and clarity.

The software tool also uses the selected input and output variables of the function blocks of the field devices 6, 7, 8, 9 to produce a system data module which stores the addresses of the field devices and the configuration of these field devices, i.e., the number of these variables and the distribution of the selected input and output variables in the process image. The software tool of the engineering system 15 transmits this system data module, which is needed to control operation of the automation device, to the automation instrument 2 which stores this system data module and also supplies the system data module, during acyclic transmission, over the first bus 10, to the slave unit 5 (DP/FF link) which likewise stores the system data module. As a result of the fact that the system data module is stored in the automation instrument 2 and the slave unit 5, the automation instrument 2 and the slave unit 5 (on the FF side) assign I/O data in the process image.

In accordance with the presently contemplated embodiment, the system data module stores only the address and the configuration of the field device 17 with the input and output variables of the associated function blocks 18. For the sake of completeness, reference is again made to the fact that the system data module also comprises data for the slave units 3, 4 which, as indicated, are not considered further.

The user uses the software tool or a further software tool to connect the selected input and output variables of the function blocks 18 and the input and output variables of the function blocks between the field devices, communication data—relating to the CiR device 19 in the presently contemplated embodiment—which are intended to be stored in the slave unit 5 (DP/FF link) are generated based on these connections and based on the number of planned field devices with associated function blocks and the number of planned CiR field devices. These communication data represent communication relationships and substantially comprise “virtual communication relationships” (VCRs), which correspond to the connections, and a scheduler which predefines, for the slave unit 5, a schedule for cyclically controlling FF communication on the second bus 11 during a macrocycle. With this scheduler, the slave unit 5 undertakes the function of a link active scheduler (LAS) of an FF configuration, where the LAS is known per se and controls a temporal progress of FF bus communication.

Lastly, the software tool is used to store parameters of a standard and/or manufacturer-specific device description in the field devices 6, 7, 8, 9, as a result of which the planning and configuration of the automation device 1 are concluded with regard to the slave unit 5 and the FF field devices 6, 7, 8, 9. In addition, the automation device 1 is prepared to implement the automation task after a start call during control operation.

The scenario may arise in which a further FF field device is connected to the second bus 11 while controlling the technical process because the automation task needs to be expanded.

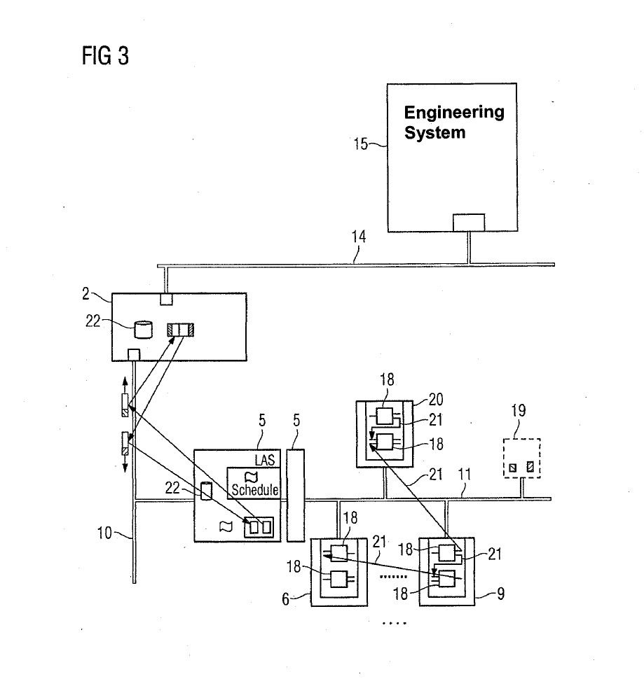

Here, reference is made to FIG. 3 which shows an engineering and runtime overview in a simplified form. The same parts which are illustrated in FIGS. 1 to 3 are provided with the same reference symbols. The CiR field device 19 depicted using dashed lines is used to indicate that the user has already also planned a CiR field device with default values for input and output variables during planning and configuration. As described herein, the automation device is thus prepared for expansion with an FF field device. The Profibus DP message that is cyclically transmitted over the first bus 10 comprises a process image data area for the planned input and output variables of the field devices 6, 7, 8, 9 and the already planned reserved process image data area with default values. As shown in FIG. 3, the reserved process image data area for the input and output variables is illustrated in hatched form. If a further field device 20 is connected to the second bus 11 during control operation (i.e., run operation) to expand the automation device, in manner as previously described the user uses the software tool to additionally select the field device with associated function blocks from the library 16 during subsequent planning, where the software tool generates an address for this field device and the highest address within the FF string (second bus 11) is allocated to the field device. The software tool produces a new system data module 22 that stores the addresses of the field devices 6, 7, 8, 9, 20 and the new FF configuration, where the new FF configuration comprises the number of input and output variables of all field devices 6, 7, 8, 9, 20 and the distribution of these variables.

The user also uses the software tool or the further software tool to again connect the input and output variables of the function blocks 18 of the field device 20 and the input and output variables of the function blocks 18 between the field devices 6, 7, 8, 9, 20, which is indicated in the figure with a reference symbol 21, where communication data is generated in the manner as previously described, and the communication data differs from the original communication data already stored in the slave unit 5 with regard to the scheduler and the “virtual communication relationships” (VCRs). With regard to calls, the macrocycle of the second bus 11 (FF bus) remains unchanged for the existing FF devices, and the macrocycle is expanded for calls from the new FF device. Only the duration of the macrocycle of the second bus 11 (FF bus) remains unchanged. The engineering system 15 loads these new communication data into the slave unit 5 using the automation instrument 2 after the parameters of a standard and/or manufacturer-specific device description have been stored in the field device 20 with the software tool. The new system data module 22 that is provided with a new time stamp is then loaded into the automation instrument 2 by the engineering system 15 and is loaded into the slave unit 5 by the instrument 2. Storing the parameters of the device descriptions in the field devices 6, 7, 8, 9, 20, and loading the communication data into the slave unit 5, and loading the system data module 22 into the automation instrument 2 and the slave unit 5 cause the new scheduler and the new “virtual communication relationships” (VCRs) to be activated on the FF side and cause data relating to the process image to be interchanged between the automation instrument 2 and the slave unit 5, with the field devices 6, 7, 8, 9, 20 connected to the latter, during cyclical control.

The engineering system generates a unique identifier (UUID) for the system data module and the communication data associated with the system data module to ensure that the “correct” communication data or communication relationships are assigned to the system data module, where the identifier is stored in the system data module and the communication data by the engineering system 15. The slave unit respectively reads the identifier and, if the slave unit 5 realizes that the system data module is not assigned to the communication data or the communication data are not assigned to the system data module, the slave unit 5 ignores the data which are transmitted from the automation instrument to the slave unit 5 over the first bus 10 during control operation and relate to the newly connected field device.

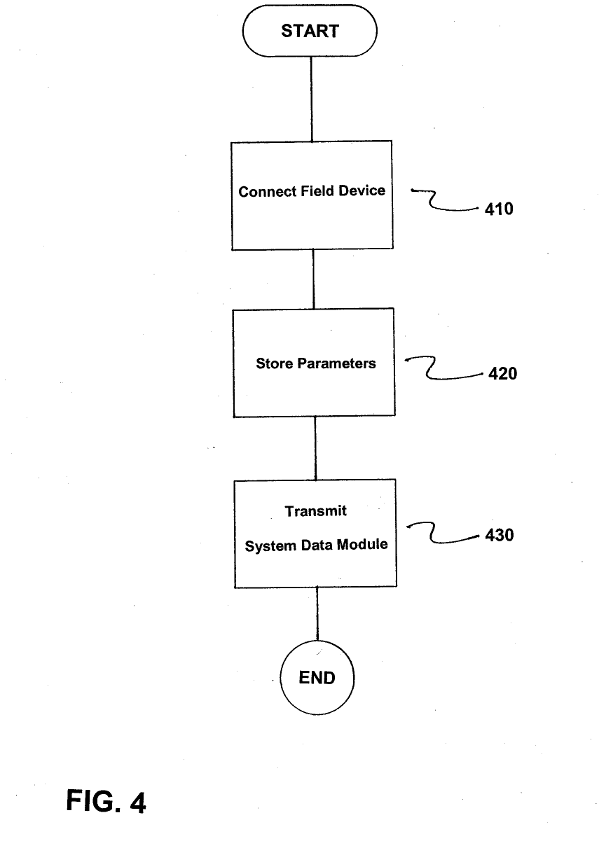

FIG. 4 is a flow chart illustrating steps of a method for operating an automation device including at least one master unit and at least one slave unit connected by a first bus, where messages are transmitted over the first bus while a technical process is controlled. Each message comprises a process image data area for planned field devices connected to the at least one slave unit by a second bus. The automation device further includes and a planned reserved process image data area configured for expansions of the automation device with at least one further field device which is connectable to the at least one slave unit. The method comprises connecting the at least one further field device to the at least one slave unit, as indicated in step 410.

Parameters of the field devices and the at least one further field device, and communication relationships of the field devices and the at least one further field device are stored in the at least one slave unit over the first bus, as indicated in step 420.

An engineering system, transmits a system data module for the at least one slave unit to the at least one master unit, as indicated in step 430. Here, the system data module is stored in the at least one master unit and the at least one slave unit and comprises addresses of the field devices, the further field device and configuration data having a number of input and output variables of the field devices and the further field device, and a distribution of the input and output variables in the process image data area.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an automation device comprising at least one master unit and at least one slave unit connected by a first bus, messages being transmitted over the first bus while a technical process is controlled, each of the messages comprising a process image data area for planned field devices connected to the at least one slave unit by a second bus, and a planned reserved process image data area configured for expansions of the automation device with at least one further field device which is connectable to the at least one slave unit, the method comprising:
connecting the at least one further field device to the at least one slave unit;
storing parameters of the field devices and the at least one further field device, and communication relationships of the field devices and the at least one further field device in the at least one slave unit, the parameters and communication relationships being received by the at least one slave unit over the first bus; and
transmitting, by an engineering system, a system data module for the at least one slave unit to the at least one master unit, the system data module being stored in the at least one master unit and the at least one slave unit and comprising addresses of the field devices and the further field device, and the system data module comprising configuration data having a number of input and output variables of the field devices and the further field device, and a distribution of the input and output variables in the process image data area.

2. The method as claimed in claim 1, further comprising:
indicating a connection of at least one of input parameters of functional modules of the field devices and output parameters of functional modules of the field devices using the communication relationships.

3. The method as claimed in claim 1, further comprising:
allocating an identifier to the system data module and the communication relationships to assign the system data module to the communication relationships.

4. The method as claimed in claim 2, further comprising:
allocating an identifier to the system data module and the communication relationships to assign the system data module to the communication relationships.

5. The method as claimed in claim 1, further comprising:
providing the further field device with ascending addresses.

6. The method as claimed in claim 1, wherein the communication relationships comprises one of schedulers and virtual communication relationships.

7. The method as claimed in claim 3, wherein the identifier is a unique identifier (UUID).

8. An automation device comprising:
at least one master unit;
at least one slave unit connected to the at least one master unit by a first bus, the at least one master unit and the at least one slave unit interchanging messages over the first bus while controlling a technical process;
planned field devices connected to the at least one slave unit by a second bus, each of the messages comprising a process image data area for field devices connected to the at least one slave unit by the second bus; and
a planned reserved process image data area configured for expansions of the automation device with at least one further field device which is connectable to the at least one slave unit;
wherein, after the further field device has been connected to the at least one slave unit, the automation device is configured to:
store parameters of the field devices and the further field device, store communication relationships of the field devices and the further field device in the at least one slave unit over the first bus; and
transmit a system data module to the master unit from an engineering system and store the system data module in the at least one master unit and the at least one slave unit, the system data module comprising addresses of the field devices and the further field device, and configuration data having a number of input and output variables of the field devices and the further field device, and a distribution of the input and output variables in the process image data area.

9. The automation device as claimed in claim 8, wherein the configuration data indicate a connection of at least one of the input parameters of functional modules of the field devices and the output parameters of the functional modules of the field devices.

10. The automation device as claimed in claim 8, wherein the at least one slave unit is configured to compare an identifier allocated to the system data module and the communication relationships.

11. The automation device as claimed in claim 9, wherein the at least one slave unit is configured to compare an identifier allocated to the system data module and the communication relationships.

13. The automation device as claimed in one of claim 5, wherein the further field device is provided with ascending addresses.

14. The method as claimed in claim 11, wherein the identifier is a unique identifier (UUID).
